(19) United States
(12) Patent Application Publication
(10) Pub. No.: US 2016/0107196 A1
(43) Pub. Date: Apr. 21, 2016

(54) Sifting Bag and Method for Storing and Sorting Plant Materials and Foods

(71) Applicant: James Rosado, Acampo, CA (US)

(72) Inventor: James Rosado, Acampo, CA (US)

(21) Appl. No.: 14/597,447

(22) Filed: Jan. 15, 2015

Related U.S. Application Data
(63) Continuation-in-part of application No. 14/515,440, filed on Oct. 15, 2014.

(51) Int. Cl. B07B 1/02; B65D 81/34; A23L 1/015

(52) U.S. Cl. CPC B07B 1/02; A23L 1/015; B65D 81/34

(57) ABSTRACT

A sifting bag and method for storing and sorting plant materials and foods includes a bag having an opening at an end of the bag adapted to receive the plant material; a perforated portion on the bag; and a plurality of apertures in a pre-selected size on the perforated portion, the size of the apertures corresponding to plant parts from a pre-selected type of plant.

### RELATED APPLICATIONS

This application claims the benefit of the filing date of U.S. patent application Ser. No. 14/515,440, filed Oct. 15, 2014, which is incorporated herein by reference in its entirety.

### BACKGROUND OF THE INVENTION

The present invention generally relates to sifters and more specifically to a sifting bag and method for storing and sorting plant materials and foods.

Existing sifters are not designed to aid in sifting, separating and storing plant parts such as, but not limited, to flowers, buds, petiole, pistols, stems, leaves, seeds, branches, shake, plant parts and plant particle dust. Desirable plant parts may be separated from less desirable plant material, referred to herein as “shake”. Usage of existing sifters to sift and sort plant material could be inefficient, and may not include a system for storing the plant material. Existing sifters could cause significant damage to delicate and sensitive plant and flower parts such as but not limited to flowers, buds, trichomes, pistols or any pubescent plants that may or may not be glandular. Existing sifters are not designed to be adaptable to separating plant parts from any plant in the Plantae Kingdom. Existing sifters may not be disposable (low cost) or able to pack into extremely small spaces such as tiny pockets or pouches.

Existing sifters are not designed for use with delicate or sensitive plant parts. Existing sifters do not allow the end user to sift and store delicate or sensitive plant materials with minimal damage to plant matter. Existing sifters may not allow the end user to sift, sort, then store delicate or sensitive plant materials with minimal shaking, and therefore do not maximize the integrity of the plant material resulting in damage and degradation of plant material. Existing sifters usually incorporate a single size of mesh screen which would not be adaptable to the numerous species of plants. Existing sifters do not incorporate an economic way of storing desirable plant material, foods or non-foods. Existing sifters do not offer a twist tie or similar system for keeping the mouth of the sifting bag secured sealed shut. Existing sifters are not designed to separate or store more desirable plant parts from less desirable plant parts. Examples of plant parts may include but are not limited to an efflorescence of flowers, from plants including but not limited to Lavender, Cannabis or Sage.

It would be desirable to have a specialized disposable combined sifter and storage device that may minimize damage to delicate or sensitive plant parts while allowing the end user to efficiently separate more desirable plant material from shake and less desirable plant material.

Existing sifters or strainers are not designed to be used to heat, cook, or cool materials including foods or non-foods or both, while also allowing the end user to sift, strain, rinse or store the materials before during or after heating, cooling, or cooking the materials in the sifting bag. Examples of foods may include turkey, noodles, vegetables, meats, etc. Examples of non-foods are containers, needles, combs, beads, etc. Existing strainers or sifters are not designed to allow the end user to heat up or cook the strainer or sifter using conventional cooking or heating methods such as but not limited to baking, boiling water, microwaving etc. Existing sifters or strainers do not have the versatility to allow the end users to have foods and/or non foods and/or plants and/or plant parts cooked in, stored in, rinsed in, and also separated in, with the possibility of multiple sifter separations, and accomplish all of this with the same sifter while being cost effective enough to be considered “disposable”. Existing sifters may not be disposable (very low cost) and/or able to pack into extremely small spaces such as tiny pockets or pouches.

As an example, Wolffia is a plant genus with small flowers. Two of the smallest species of Wolffia are the Australian Wolffia angusta and the Asian/African Wolffia globosa. Both species are so small that it is difficult to distinguish between the size of their fruits. Since the entire plant body of these two species is less than one millimeter long (less than 1/25th of an inch), the tiny mature fruit takes up most of its parent plant body. The fruit of W. angusta is only 0.30 mm long ( 1/100th of an inch) and weighs about 70 micrograms ( 1/400,000 of an ounce). One can get an idea of how small these fruits really are when you consider that an average, single, cubical grain of ordinary table salt (NaCl) is about 0.30 mm on a side and weighs about 60 micrograms. This fruit is smaller than the individual cells of many plants and animals, and is more than 4 billion times lighter than a massive world class pumpkin.

It would be desirable to have a specialty disposable sifting cooking bag that would allow the user to cool, heat, cook, store, sift or strain, and/or rinse foods or non-foods in the bag.

### SUMMARY OF THE INVENTION

In one aspect of the present invention, a device for sorting and storing a plant material includes a bag having an opening at an end of the bag adapted to receive the plant material; a perforated portion on the bag; and a plurality of apertures in a pre-selected size on the perforated portion, the size of the apertures corresponding to plant parts from a pre-selected type of plant.

In another aspect of the present invention, a method of sorting plant material includes selecting a type of plant material having a specified seed size; providing a sorting device that includes a bag having a sealable opening at an end of the bag adapted to receive the plant material, a lower, perforated portion on the bag, and an upper, solid portion on the bag that includes the flexible material in a generally solid sheet; providing a plurality of apertures in a pre-selected size on the perforated portion of the bag, the size of the apertures corresponding to the specified seed size; inserting the plant material into the sorting device; sealing the opening; lifting the device; and shaking the sorting device so that the seeds of the plant material pass through the apertures, thereby sorting the plant material.

In a further aspect of the present invention, a method includes providing a bag having an opening at an end of the bag adapted to receive a material, the bag having an upper, solid portion on the bag that includes a flexible material in a generally solid sheet, the upper portion providing a sealable opening at a top of the device and a container area that retains the material, the bag having a perforated portion on the solid portion, the bag having a plurality of apertures in a pre-selected size on the perforated portion; and utilizing the bag for cooling, heating, cooking, storing, straining, or separating the material.

### BRIEF DESCRIPTION OF THE DRAWINGS

FIG. 1 depicts an embodiment of the present invention;

FIG. 2 depicts another embodiment of the present invention;

FIG. 3 depicts two embodiments of the present invention;

FIG. 4 depicts a method of inserting a perforated bag into another bag according to the present invention;

FIG. 5 depicts an embodiment of the present invention for cooking a turkey, according to the present invention;

FIG. 6 depicts an embodiment of the present invention for cooking a turkey in an oven, according to the present invention;

FIG. 7 depicts an embodiment of the present invention having a first perforated bag within a second page according to the present invention;

FIG. 8 depicts an embodiment of the present invention with a pot;

FIG. 9 depicts an embodiment of the present invention in use;

FIG. 10 depicts an embodiment of the present invention with a bowl;

FIG. 11 depicts an embodiment of the present invention with a tie;

FIG. 12 depicts an embodiment of the present invention with a two bags with ties; and

FIG. 13 depicts an embodiment of the present invention with a two bags with one tie.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Embodiments of the present invention may include devices for sorting plant material, having a bag with pre-selected apertures designed to sort seeds from a pre-selected plant.

Embodiments may be made of known materials. Embodiments may include food grade nylon or polyester. Embodiments may be “food grade”, meaning that the product material is known to be safe for use with plant material and seeds intended for consumption or ingestion by humans or animals. Embodiments may be “disposable” in that they are made from a material that is cost-effective to use only once or only for a short time. This might be because the material is a low cost material. Alternate embodiments may be made of biodegradable plastic or other material suitable for handling food. Embodiments of material suitable for food may have a permeability suitable for food. Embodiments may be approved by the U.S. Food and Drug Administration (“FDA”) to meet permeability standards for storing food.

Embodiments of bags for sifting plant parts, shake or seeds may include turkey size (19″×23½″) or larger. It may also be smaller, such as (16″×17½″), or sizes in-between. A preferred embodiment may include bag for sorting plant parts from any plant in the Plantae Kingdom. An aperture size for sorting seeds or plant parts may be round, with a diameter of 1/1000″ to 1″. A preferred aperture for sorting seeds from any plant such as the seeds from Sage, Cannabis, or Lavender flowers, may be or oval or seed shaped, having a length or major axis of 1/100″ to 1″ or smaller, and a width-to-length ratio of 50% to 100%.

In an embodiment of the invention, a user may first provide an appropriate bag for sifting seeds or other sorting of plant parts such as but not limited to “shake.” Embodiments of sorting bags may include food-quality plastic bag with apertures at the bottom and lower sides of the bag or apertures may cover anywhere from 1% to 100% of the bag.

Embodiments of sorting bags may include containers or bags to collect the sorted materials. Collection containers may include a wastebasket like or trashcan like basket that site below the bag. The bag may have an upper area or top of the device that corresponds to top of the container so that the bag generally covers the top of the container. A user may install the sorting bag in the top of the container or into another bag, use the bag/s to shake the plant material, and the plant parts such as but not limited to pistols, seeds, stem, leaf or flower bits that are separated from the bag will fall into the container or second bag.

Different bags may be designed for different types of plant material. Bags may have appropriate total dimensions and appropriately sized and shaped apertures for different kinds of plant parts such as seeds or “shake” to be sorted. For example, the apertures may be seed shaped or oval, so as to tend to sort out seeds. The apertures may be of a pre-selected size for a pre-selected type of material, e.g. apertures about the size and shape of a different seeds, and a bag large enough for perhaps 1 pound or more or less of plant parts from plants such as but not limited to cannabis, sage, or lavender such as a “turkey bag,” “oven bag,” “baking bag,” or “cooking bag”.

Embodiments may sort out the “shake,” plant parts, particles, and seeds. Embodiments may provide a method to separate plant material. Embodiments may be used to store sifted or unsifted plant material or cooked or uncooked food or non-foods. Embodiments may be used as a sifting bag using a collection container similar to the tabletop sifter.

An upper portion of a bag may be a generally solid upper sheet in that the sheet is a plastic sheet that can be firmly grasped by a user and is strong enough to form an opening at the top of the bag. The opening at the top of the devise may be a releasable opening. Embodiments may include a device such as a twist tie or similar to secure the sifter bag's opening shut.

In an embodiment, a user may also provide a food in addition to the plant material in the bag, which may be, for example, a turkey. The user may cook the food in the bag, thereby providing food materials including food particles, grease, or oil in the bag, in addition to the plant material to be separated. The user may first coat the inside of the bag with food powders to help with cooking of the food, such as, for example, baking powder, flour, or spices. The user may shake the bag to remove the food particles. This may be before, after, or at the same time that the user shakes the bag to remove seeds and other plant material from the bag.

Embodiments may include a method to cook and separate foods from their own juices, fats, smaller particles and/or other foods, spices, or herbs. Embodiments may be combined with existing methods for “turkey bag,” “oven bag,” “baking bag,” or any other “cooking bag” systems that may be constructed from any heat resistant food grade nylon or polyester. Embodiments may sift larger from smaller food matter or cooked foods from their juices or other food or non-food particles. Embodiments of a bag may be partially mesh, such as where the very bottom only is mesh, the bottom half is mesh, or 100% of the bag is mesh. The bag may incorporate built in handles or any other device used for ease of handling of the bag. Said handles may also work as a way of securing a bag shut, such as a string that may be incorporated into the lip of the bag opening and used much like a belt to secure the bag shut while offering the end user another method to handle the bag. A user may install the sorting bag into another solid food grade heat resistant bag, use the sifting bag to separate the food or non-food materials. The food or non-food matter such as but not limited to grease, juices, oils, spices, plant parts, smaller particles that are separated from the bag will fall into the second solid bag.

In another embodiment, a method may utilize a sorting bag for cooling, heating, cooking, storing, straining, and/or separating material that may include foods. An embodiment of a disposable sifting cooking bag or bag liner may have an opening at an end of the bag adapted to receive the foods and/or non-foods. The bag may have a lower, perforated portion on the bag, and an upper, solid portion on the bag that includes a flexible material in a generally solid sheet that provides a sealable opening at a top of the device and a container area that retains the foods and/or non-foods. The lower portion may have a plurality of apertures in a pre-selected size on the perforated portion, the size of the apertures corresponding to the foods and/or non-foods being used. Hole size may vary in order to separate different food and/or non-food sizes. Embodiments of bags may have heat resistant handles built in or attached for ease of handling. A sifting bag may be filled with food and/or non-foods then tied shut and then may be inserted into a cooking bag that is tied shut, a pot, pan, or any cooking dish or sheet which could contain the filled sifter bag. The bag may then be placed into a preheated oven as long as desired. If using a cooking bag, the user would open the cooking bag when desired then lift out and/or gently shake the sifter bag to separate the foods or non-foods from their juices and or smaller foods or non-foods and/or smaller particles. The user could then untie the sifter bag and remove the sifted food. A user may also place the sifter bag with food or non-foods into a pot full of water, with or without placing into a cooking bag first. The food may then be cooked or soaked for as long as desired after sealing the bag. Then the user would open the cooking bag (if a cooking bag was used). Lifting and/or gently shaking the sifter bag will remove juices and/or smaller particles, foods or non-foods that a user wishes to separate. Then the user could open the sifting bag and remove the sifted foods or non-foods. A user may also use the sifting bag to rinse cooked, heated, or unheated foods or non-foods. A user may use a sifter bag to submerge foods or non-foods into a container of hot warm cold or ice water in order to change the temperature of the foods or non-foods. A sifter bag may be accompanied by a solid non-perforated heat resistant food grade nylon or polyester bag to be used to help contain moisture, grease, oils, or any other smaller particles before or after being sifted.

Embodiments may use the bag to sift Wolffia seeds with apertures about 1/100th of an inch in diameter. Embodiments may use the bag to sift mustard seeds which would have holes approx 1/16th of an inch, or sesame seed sifting which would require approx ⅛th of an inch to sift. To sift sunflower seeds the bag holes might be from ½ to ¾ inches.

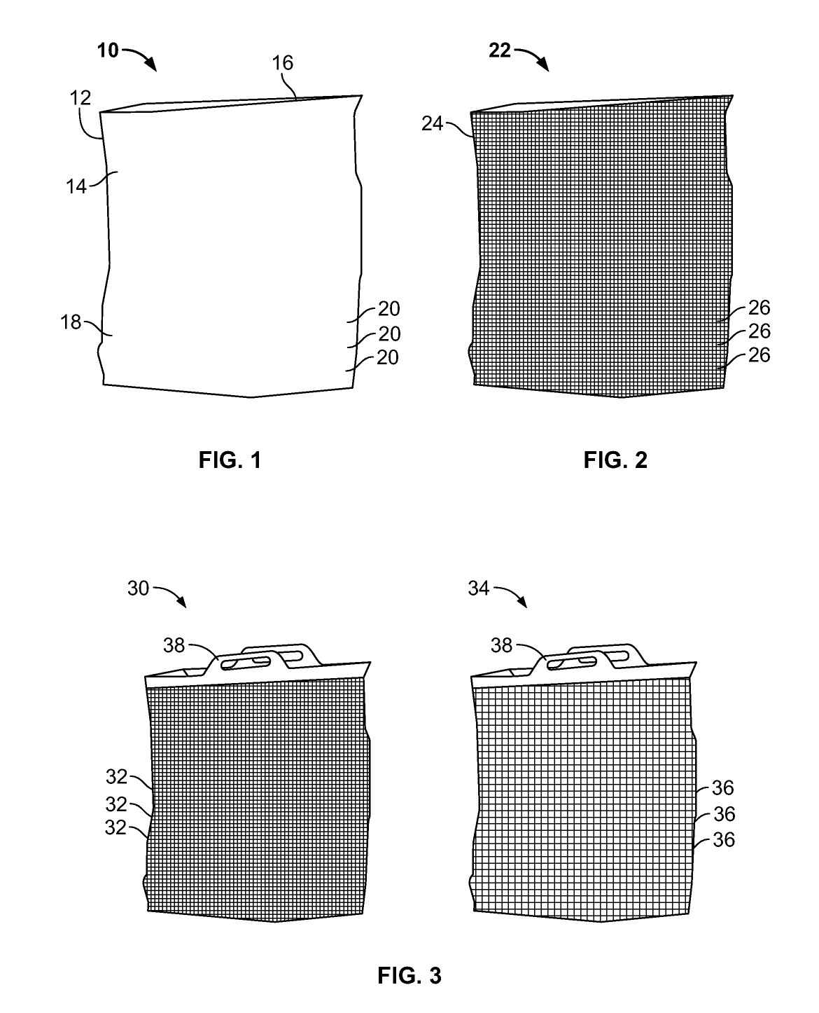

As depicted in FIG. 1, an embodiment of a sorting device 10 may include a bag 12 having an upper portion 14 that provides a sealable opening 16, and a lower portion 18 having a plurality of apertures 20. The apertures 20 may be sized to accommodate seeds, shake or any desirable or undesirable plant parts of a pre-selected plant material. The upper portion 14 may be generally solid, to help retain plant material, and lower portion 18 may have the apertures 20 so that plant material at the bottom of the bag 12 will be shaken against the bag, and seeds, shake or desired or undesired plant parts of the plant material will tend to fall out of the apertures 18.

As depicted in FIG. 2, an embodiment of a sorting device 22 may include a bag 24 having a plurality of apertures 26. The apertures 26 may be sized to accommodate plant parts of a pre-selected plant material so that plant material at the bottom of the bag 24 will be shaken against the bag, and plant parts from the plant material will tend to fall out of the apertures 26.

As depicted in FIG. 3, embodiments of a sorting device may include large bags and small bags having different aperture sizes. A first example bag 30 may have apertures 32 with a first, small size, and a second example bag 34 may have apertures 36 with a second, larger size. A user may pre-select the type of aperture needed, and then provide the appropriate embodiment. The embodiments may also have handles 38 at the top that help close the opening at the top and which help a user carry the device.

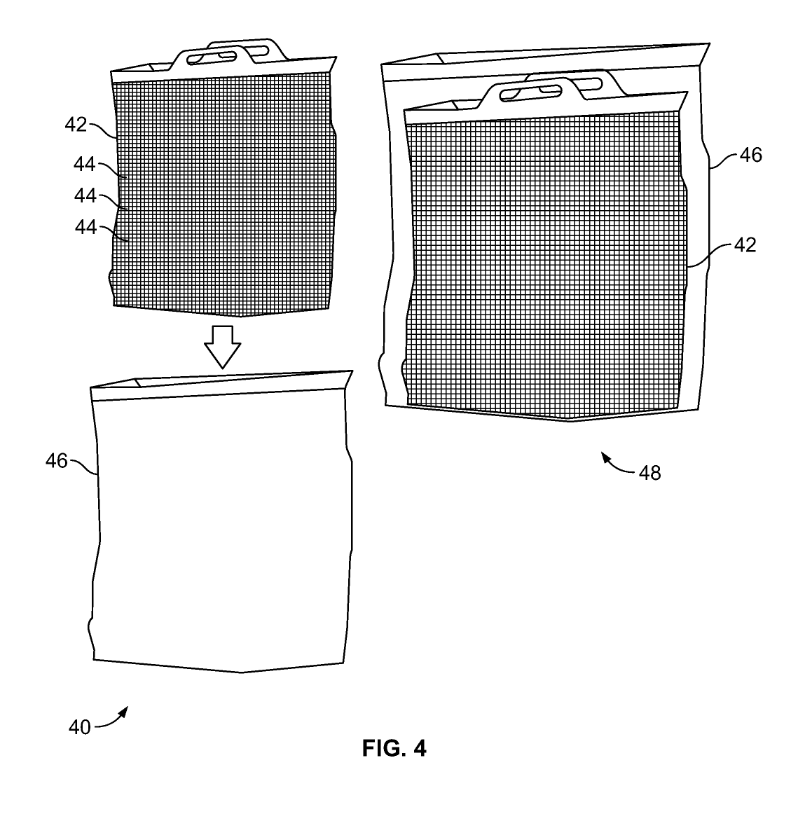

As depicted in FIG. 4, an embodiment of a method 40 may include inserting or fitting a bag 42 having apertures 44 into a second bag 46 that is solid or generally impermeable to leaf material. This provides a system 48 having an inner bag 42 having sides with apertures within an outer bag 46 with solid sides. The outer, generally impermeable bag 46 will retain the “shake” that is released from the inner, perforated bag 42.

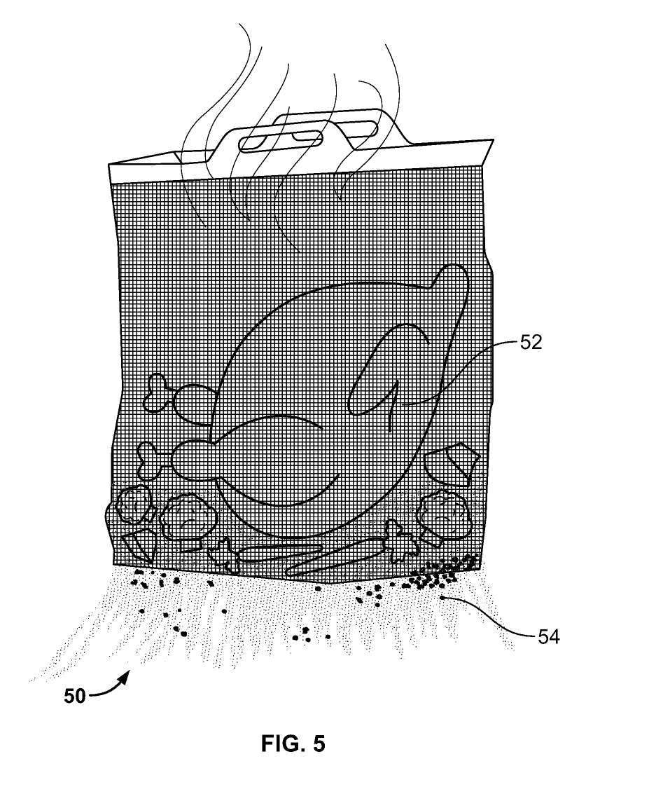

As depicted in FIG. 5, an embodiment and system 50 for cooking may include placing a turkey 52 or other food or non-food material may separate materials such as turkey or chicken stock from other materials 54 such as vegetables and other plant material.

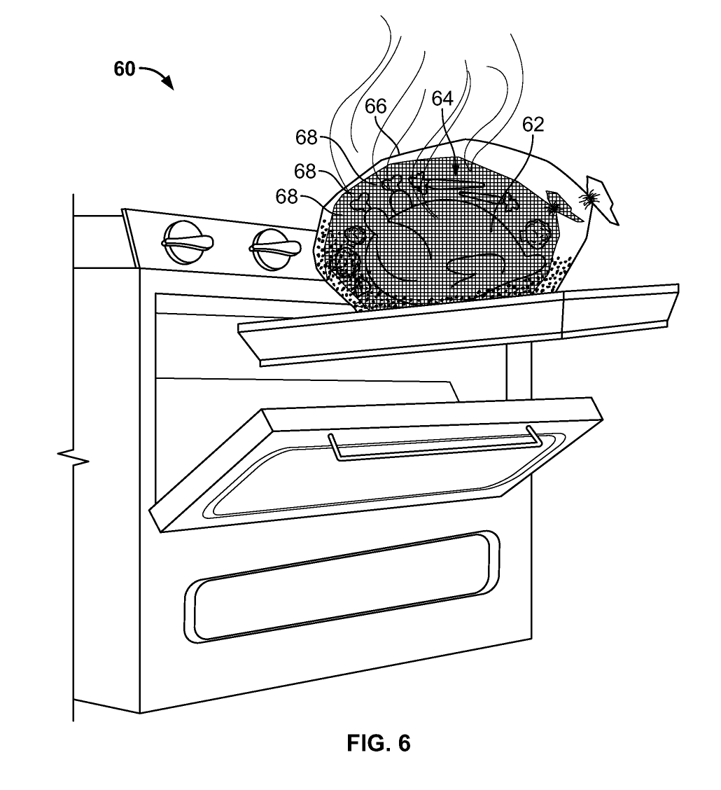

As depicted in FIG. 6, an embodiment and system 60 for cooking may include a turkey 62 within an interior bag 64, within an exterior bag 66. The interior bag 64 may have a plurality of apertures 68.

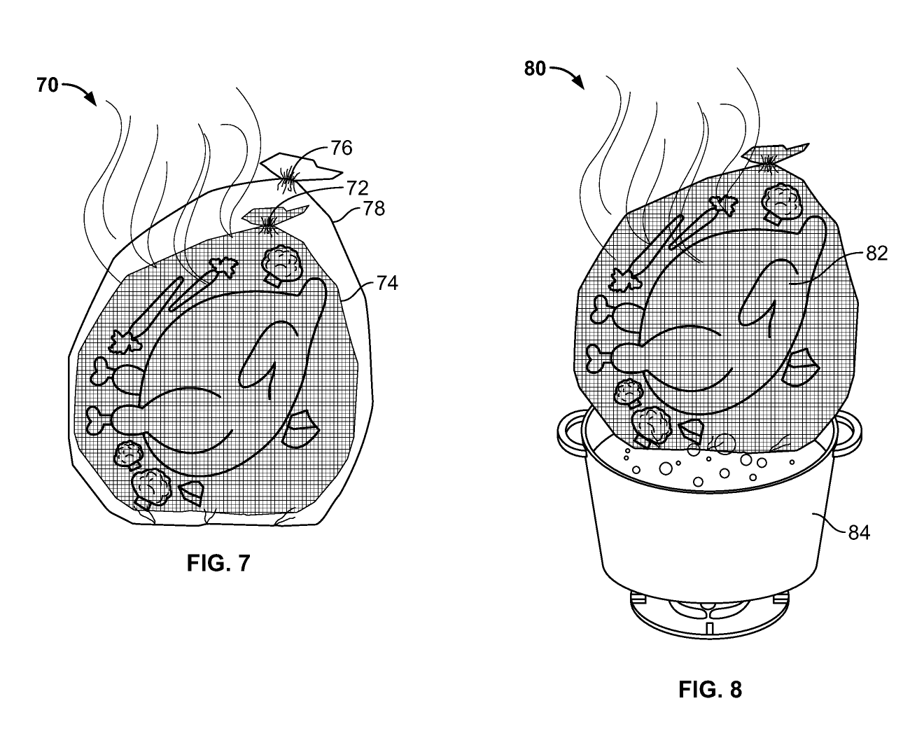

As depicted in FIG. 7, an embodiment of a cooking system 70 may be tied inside with a tie 72 on the interior, perforated bag 74, and be tied with a tie 76 on the outer container bag 78.

As depicted in FIG. 8, an embodiment of a cooking system 80 may include food 82 in a pot 84 or sifter. Embodiments may include a device which is a sifter/stockpot combination that retains the food and sorts leaf material out of the food.

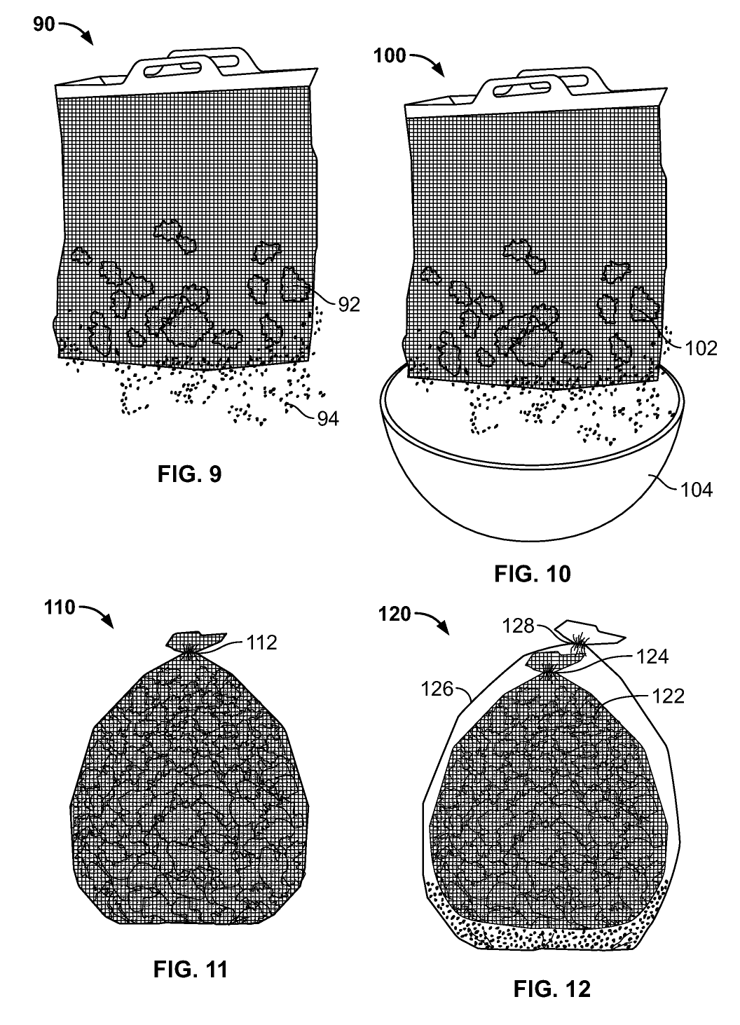

As depicted in FIG. 9, embodiments of a bag 90 may sift sifting small leafy material 92 to result in shake 94.

As depicted in FIG. 10, embodiments of a bag 100 may sift small leafy material 102 into a bowl 104.

As depicted in FIG. 11, embodiments of a bag 110 may include a tie 112 the top.

As depicted in FIG. 12, embodiments of a bag 120 may include a first bag 122 with a first tie 124, inside a second bag 126 with a second tie 128.

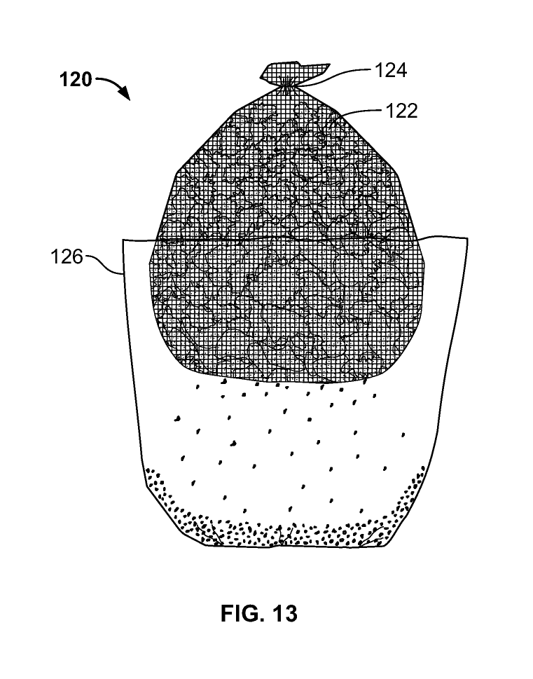

As depicted in FIG. 13, embodiments of a bag 120 may include a first bag 122 with a tie 124, inside a second bag 126 with no tie.

I claim:

1. A device for sorting and storing a plant material, comprising:
a bag having an opening at an end of the bag adapted to receive the plant material;
a perforated portion on the bag; and
a plurality of apertures in a pre-selected size on the perforated portion, the size of the apertures corresponding to plant parts from a pre-selected type of plant.

2. The device of claim 1, wherein the plant parts are seeds of the plant.

3. The device of claim 1, further comprising:
an upper portion on the bag that includes the flexible material in a generally solid sheet;
wherein the opening at the top of the device is sealable; and
the upper solid sheet forms a container area that retains the plant material.

4. The device of claim 1, wherein the opening at the top of the devise is a releasable opening that seals for storage and then releases.

5. The device of claim 1, further comprising a lining of food powder, thereby helping the device store food.

6. The device of claim 1, further comprising a container to catch the plant parts that pass through the apertures.

7. The device of claim 1, further comprising a container that cooperates with bags, so that the bag fits at a of top the container, and a shape of the opening at the top of the bag corresponds to a shape of an opening at the top of the container.

8. The device of claim 1, wherein the apertures are 1/100 inch to 1 inch along a major axis of each aperture.

11. The device of claim 1, wherein a width of the bag may be 16″ to 19″ and a length of the bag may be 17½″ to 23½″.

12. The device of claim 1 further comprising a second device for sorting a second plant material, wherein the apertures of the second device are of a different, second size than the apertures of the device, thereby providing a second device adapted to sort a second type of plant material having seeds of the second size.

13. A method of sorting plant material, including:
selecting a type of plant material having a specified seed size;
providing a sorting device that includes a bag having a sealable opening at an end of the bag adapted to receive the plant material, a lower, perforated portion on the bag, and an upper, solid portion on the bag that includes the flexible material in a generally solid sheet;
providing a plurality of apertures in a pre-selected size on the perforated portion of the bag, the size of the apertures corresponding to the specified seed size;
inserting the plant material into the sorting device;
sealing the opening;
lifting the device; and
shaking the sorting device so that the seeds of the plant material pass through the apertures, thereby sorting the plant material.

14. The method of claim 13, further comprising:
placing a container beneath the bag; and
collecting the seeds of the plant material that pass through the apertures of the bag in the container.

15. The method of claim 13, further comprising:
providing a food in addition to the plant material in the bag;
cooking the food in the bag, thereby providing food parts and juices in the bag; and
further shaking the sorting device so that the food parts pass through the apertures, thereby sorting the foods and juices.

16. A method comprises:
providing a bag having an opening at an end of the bag adapted to receive a material, the bag having an upper, solid portion on the bag that includes a flexible material in a generally solid sheet, the upper portion providing a sealable opening at a top of the device and a container area that retains the material, the bag having a perforated portion on the solid portion, the bag having a plurality of apertures in a pre-selected size on the perforated portion; and
utilizing the bag for cooling, heating, cooking, storing, straining, or separating the material.

17. The method of claim 16 wherein:
the holes have a pre-selected size that adapts the bag to separate a specific material having a size;
the bag is adapted to have heat resistant handles;
the bag is filled with the material then tied shut;
the bag is inserted into a closed cooking bag, pot, pan, cooking dish, or sheet; and
the method further comprises placing the bag into a preheated oven.

18. The method of claim 16, wherein:
the material includes a food, and the bag cooks and separates the food from non-food material.
